(19) United States
(12) Patent Application Publication
(10) Pub. No.: US 2012/0296456 A1
(43) Pub. Date: Nov. 22, 2012

(54) GOLF HANDICAP APPLICATION FOR MOBILE DEVICES

(76) Inventor: Patrick D. Jentz, Sammamish, WA (US)

(21) Appl. No.: 13/476,919

(22) Filed: May 21, 2012

Related U.S. Application Data
(60) Provisional application No. 61/488,109, filed on May 19, 2011.

(51) Int. Cl. G06F 19/00

(52) U.S. Cl. 700/93

(57) ABSTRACT

Technology is described for tracking golf handicaps. The technology receives an identification of one of at least two golf handicap rating agencies a user is affiliated with; receives a golf score for the user; and electronically provides the received golf score to the identified rating agency.

### CROSS-REFERENCE TO RELATED APPLICATION(S)

This patent application claims the benefit of U.S. Provisional Patent Application Ser. No. 61/488,109 (attorney-docket number 77310-8001.US00) entitled “MOBILE PHONE APPLICATION USED TO ESTABLISH AND MAINTAIN GOLF HANDICAP” filed on May 19, 2011, the contents of which are incorporated herein by reference in its entirety.

### BACKGROUND

Millions of people around the world play golf and most of them play recreationally. Both recreational golf players and professional golf players commonly refer to a measure of their golf playing ability as a golf “handicap.” A handicap is a numerical measure of a golfer's playing ability and is usually a function of the golfer's score at various golf courses and a computed difficulty of these golf courses. Each golfer's handicap is used to calculate a net score based on the golfer's nominal score for a particular play (e.g., score after playing an 18-hole “round” of golf at a particular golf course) and enables comparison of scores of multiple golf players at any given course, e.g., during a tournament. Handicaps are administered by golf clubs or national golf associations, and the rules relating to computation of handicaps can vary between the clubs and associations.

To report their golf scores to the golf associations, golfers sometimes employ outdated computing equipment located at golf courses. This equipment at gathers golf scores from players and reports the scores to the golf association with which the course is affiliated. The golf association then computes a revised handicap for each player who reports his or her score and provides the revised handicap to the user and others, e.g., online at the golf association's web site.

Two golf courses may belong to different golf associations and thus golf players are sometimes unable to report scores from golf courses or tournaments because those courses or tournaments are not administered by the golf association with which the players may be affiliated. Thus, players sometimes join multiple different golf associations and so have multiple different golf handicaps even though the handicaps are similarly computed by all golf associations.

### BRIEF DESCRIPTION OF THE DRAWINGS

FIG. 1 is a block diagram illustrating an environment in which the described technology may operate in various embodiments.

FIG. 2 is a flow diagram illustrating a routine invoked by the described technology in various embodiments, e.g., to report golf scores.

FIG. 3 is a flow diagram illustrating a routine invoked by the described technology in various embodiments, e.g., to register users.

FIG. 4 is a block diagram illustrating components that the described technology may employ in various embodiments.

FIGS. 5-59 are user interface diagrams illustrating user interface features employed by the described technology in various embodiments.

### DETAILED DESCRIPTION

Technology is described herein to implement a golf handicap application for use by golfers (“described technology”), e.g., using mobile computing devices. In various embodiments, the described technology can report golf scores to multiple golf associations, as appropriate, and can compute a recreational handicap across multiple golf associations, e.g., so that players can compare their relative ability no matter with which golf association they may be affiliated.

Users can register with a server, e.g., using a web site or client software executing on a mobile computing device (e.g., iPhone, Blackberry, Android device, etc.) and then can use the client software to interact with one or more golf agencies (e.g., golf associations, golf clubs, handicap computation services, etc.) Users can also select whether they desire to use the services of a golf association with which they are affiliated (e.g., the U.S. GOLF ASSOCIATION®), some other golf agencies, e.g., an entity that commercializes the technology described herein (“DiabloGolf”), or both. Users can then employ the application as described herein, e.g., to locate golf courses, retrieve handicap information, report golf scores, interact with other golfers, etc.

In various embodiments, the technology enables users to select a nearby golf course, e.g., so that when they report a golf score, the technology can associate the score with a particular golf course. As an example, the technology can receive geolocation information from a GPS device associated with the user's mobile computing device and retrieve a list of golf courses nearby that location. The golf courses may be listed in order of distance from the user's current location. The user can then select a golf course from among the golf courses. The user can also, of course, select golf courses by typing portions of names, searching for names, locations, etc.

After a user has selected a golf course, the technology can provide the user with an electronic score card for the selected golf course. Golfers can use score cards to keep track of their golf strokes and the strokes of the people with whom they are playing. An electronic score card may be similar to conventional score cards, but presented electronically on the user's mobile computing device. The score cards usually contain include slope and rating values that are used to compute handicaps.

After concluding a round of golf (e.g., after play of 9 or 18 holes), users can “post” their scores, e.g., to a server. The posting can be made to a golf association server and/or a server controlled by other handicap service. In various embodiments, the user may need to validate himself or herself, e.g., by providing authentication information.

The user can also view historical golf scores. As examples, the user can view their own scores or the scores of other golf players at the presently selected golf course or at other golf scores that were previously posted. In various embodiments, the user can view golf scores posted for the last twenty or more rounds.

The user can also employ the technology to compute their golf handicap. In various embodiments, the technology can retrieve handicap information from golf association servers or other servers and/or compute the handicap immediately, e.g., by including scores from one or more rounds just played by the user. In doing so, the user does not need to wait for the golf association's servers to update golf handicap information, which can sometimes take days to be updated. The user can also employ the technology to compute a course handicap so that the user can determine what their score should be for the selected golf course.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection.

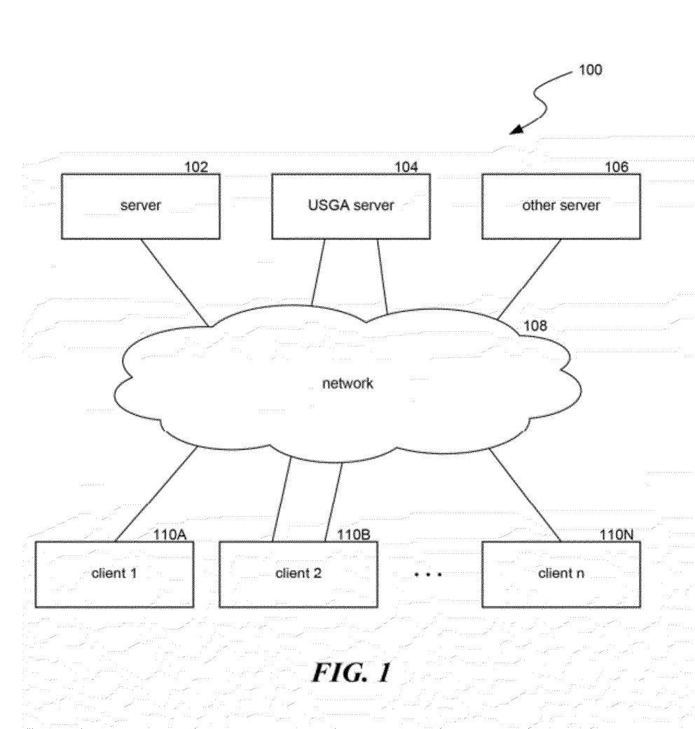

FIG. 1 is a block diagram illustrating an environment 100 in which the described technology may operate in various embodiments. The environment 100 can include servers 102, 104, and 106. The servers can be employed by one or more entities that compute handicaps or provide other golf-related information. As an example, server 102 may provide data relating to golf courses; server 104 may provide handicap information for users and receive user scores after rounds of golf; and server 106 can provide other information, e.g., to golf applications executing on mobile computing devices. The servers may operate independently or under control of a common entity. In various embodiments, server 104 provides services relating to an application program interface (“API”) employed by a golf association, e.g., the U.S. Golf Association to receive scores and provide handicaps. In various embodiments, server 102 provides services relating to application program interface employed by a recreational handicap golf service, e.g., a DiabloGolf service commercialized by the present assignee of this patent application. The servers can have one or more communications links with a network 108, e.g. an intranet or the Internet. The network may have one or more communications links with client computing devices, e.g., client computing devices 110A, 110B, and 110N. the client computing devices can be mobile computing devices or other types of computing devices.

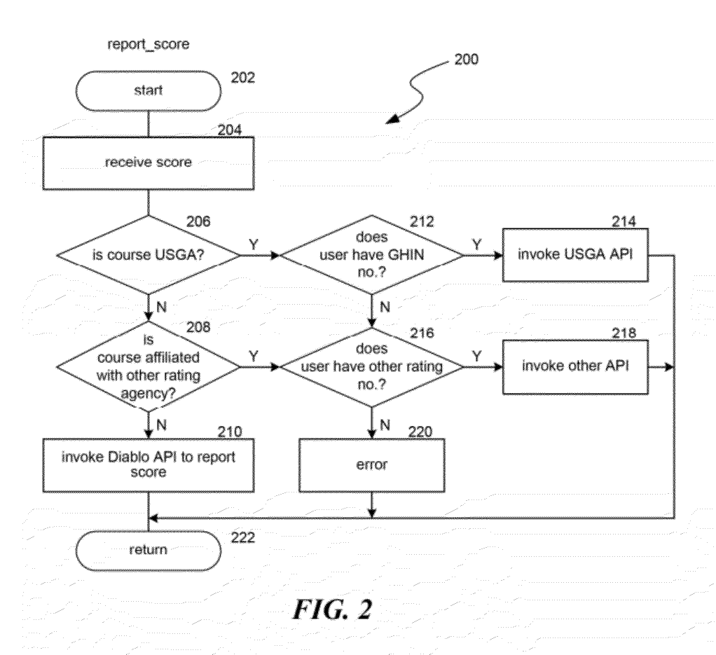

FIG. 2 is a flow diagram illustrating a routine 200 invoked by the described technology in various embodiments, e.g., to report golf scores. The routine 200 begins at block 202. At block 204, the routine receives a golf score, e.g., from a user employing an application executing on a mobile computing device. At decision block 206, the routine determines whether the user played at a golf course associated with the U.S. Golf Association (“USGA”). As an example, the routine may have received input from the user indicating which course that the user played on. If the golf course is associated with the USGA, the routine continues at decision block 212. Otherwise, the routine continues at decision block 208. At decision block 208, the routine determines whether the user played at a golf course associated with a different golf association or golf course rating agency other than the USGA. If the user played a golf course associated with a different golf association or golf course rating agency other than the USGA, the routine continues at decision block 216. Otherwise, the routine continues at block 210. At block 210, the routine invokes an API to report the user's score to a recreational handicap reporting entity, e.g., DiabloGolf. The routine then returns at block 222. At decision block 212, the routine determines whether the user has a “GHIN”® number. Many golfers affiliated with the USGA have a GHIN number that identifies their golf handicap and associates reported scores with the golfers. If the user has a GHIN number, the routine continues at block 214. Otherwise, the routine continues at decision block 216. At block 214, the routine invokes an API provided by the USGA to report the received score. The routine then returns at block 222. At decision block 216, the routine determines whether the user has a different rating number, e.g., a rating number for a different rating agency. If the user has a number associated with a different rating agency than the USGA, the routine continues at block 218. Otherwise, the routine continues at block 220. At block 218, the routine invokes an API provided by the other rating agency to report the received score. The routine then returns at block 222. At block 220, the routine reports an error to the user indicating that the score could not be reported. The routine then returns at block 222.

Those skilled in the art will appreciate that the logic illustrated in FIG. 2 and described above, and in each of the flow diagrams discussed below, may be altered in a variety of ways. For example, the order of the logic may be rearranged, substeps may be performed in parallel, illustrated logic may be omitted, other logic may be included, etc.

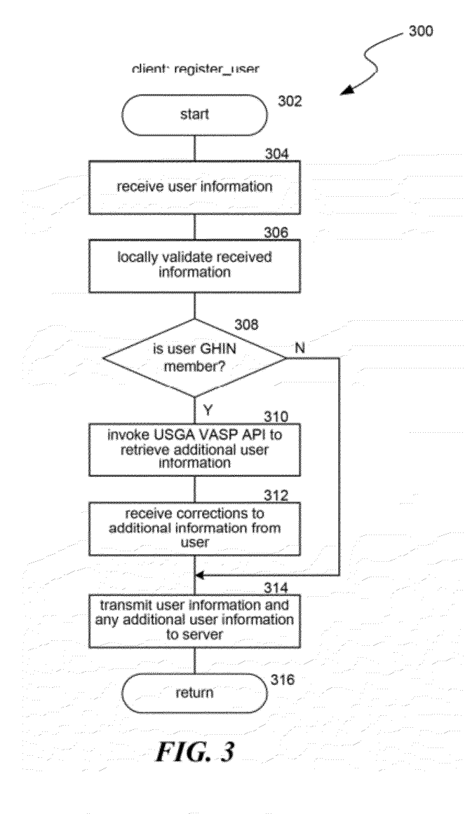

FIG. 3 is a flow diagram illustrating a routine 300 invoked by the described technology in various embodiments, e.g., to register users. The routine 300 begins at block 302. At block 304, the routine receives user information. As examples, the routine may receive a user's name, GHIN or other handicap rating agency number, password, etc. At block 306, the routine validates the received user information, e.g., with a server. If at decision block 308 the routine determines that the user is a USGA member (e.g., has a CHIN number), then the routine continues at block 310. Otherwise, the routine continues at block 314. At block 310, the routine invokes an API provided by a USGA server to retrieve additional information relating to the user. As examples, the routine may retrieve recent scores, name, contact information, etc. At block 312, the routine may receive corrections to the additional information retrieved from the server. As an example, the user may update scores, contact information, etc. At block 314, the routine transmits the received user information and the updated additional information to a server. The routine then returns at block 316. Although a USGA server providing a CHIN API is described, other servers can be employed.

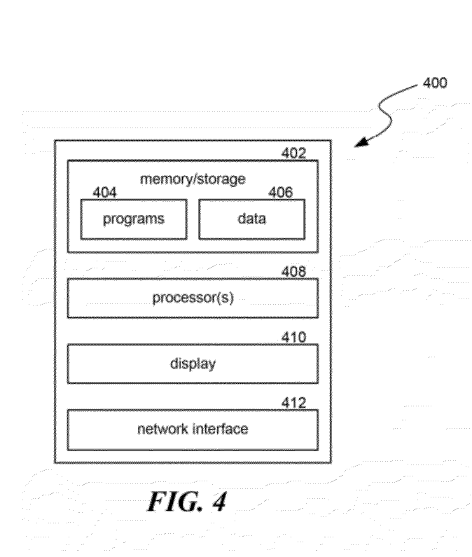

FIG. 4 is a block diagram illustrating components 400 that the described technology may employ in various embodiments. The components 400 can include memory or storage 402, one or more processors 408, a display 410, a network interface 412, and other components (not illustrated). The memory 402 can include programs 404, data 406, and other information (not illustrated).

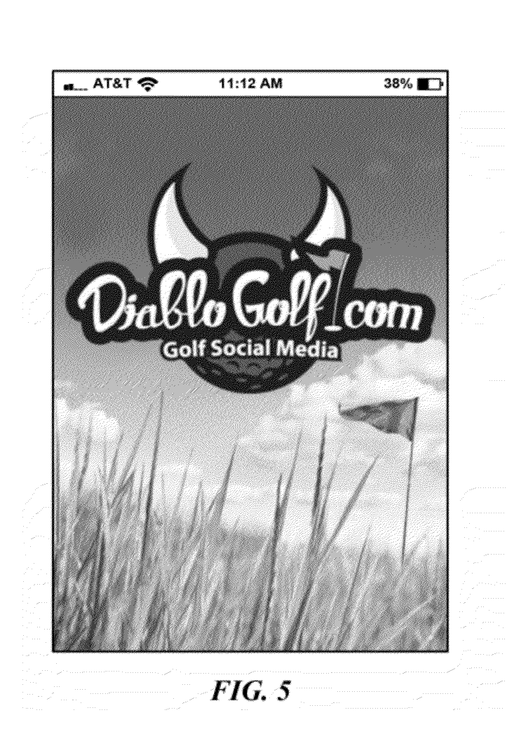

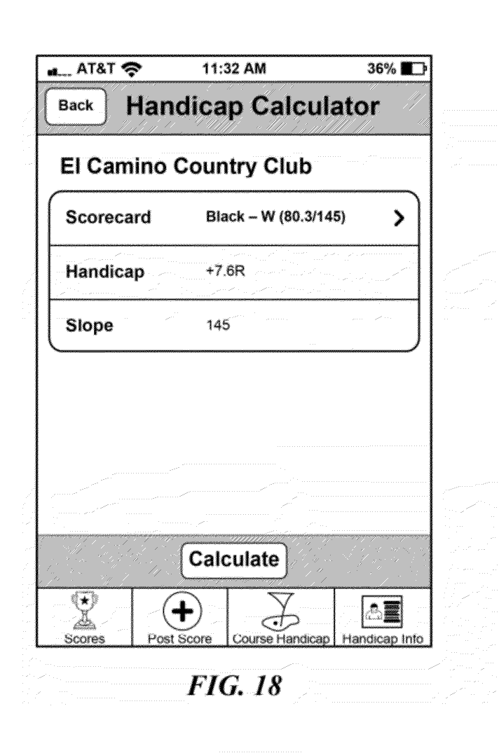

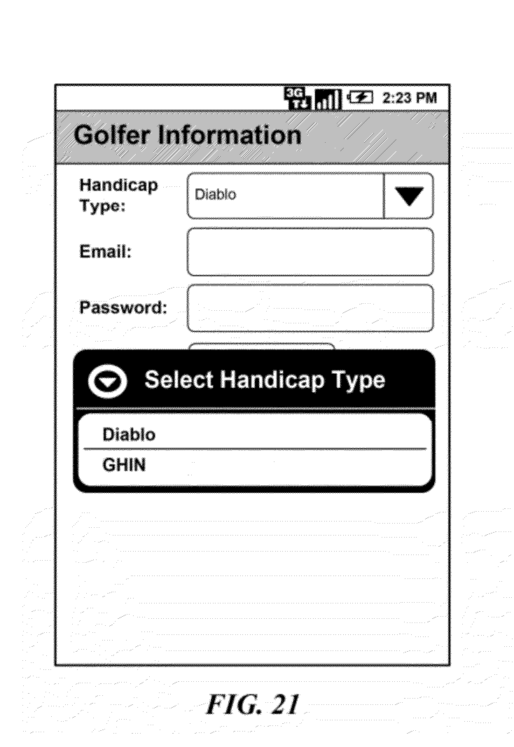

FIGS. 5-59 are user interface diagrams illustrating user interface features employed by the described technology in various embodiments.

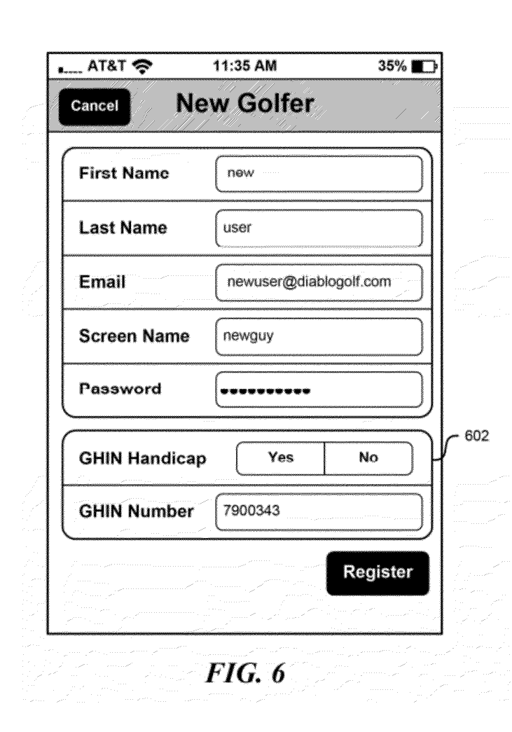

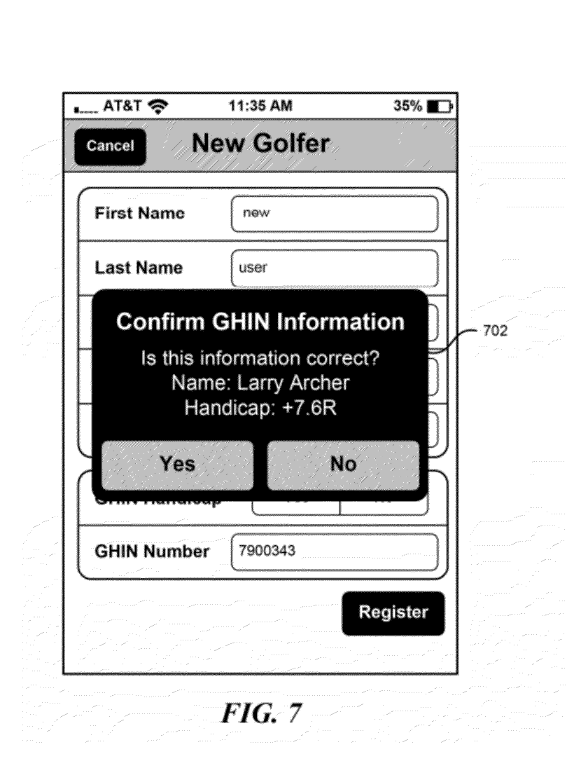

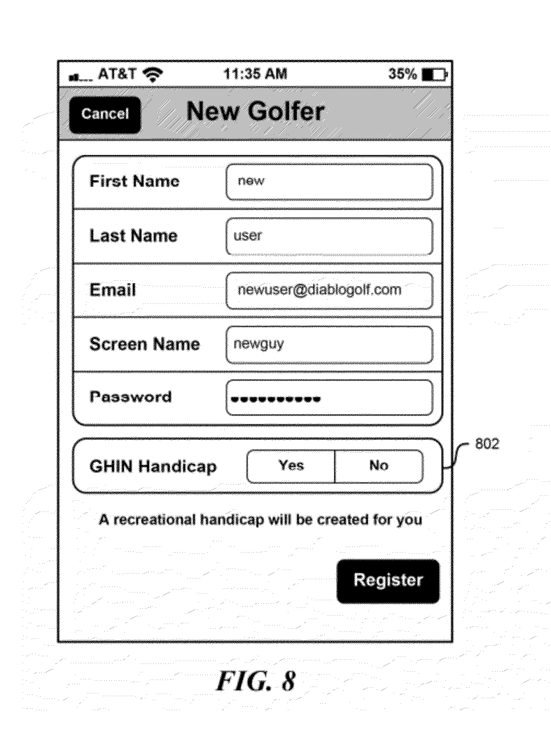

FIG. 5 illustrates a splash screen that may appear when a user launches client software corresponding to the described technology. FIG. 6 illustrates a user interface for receiving information from a new golfer. If the new golfer provides a CHIN number in region 602, the user is assumed to be a USGA member. If the user indicates in region 602 that the user does not have a CHIN number or handicap, the client software may enable the user to set up an account to register scores for receiving a recreational handicap. In various embodiments, the client software can function with other golf handicap computation agencies, e.g., golf associations. FIG. 7 illustrates a user interface for receiving confirmation from the user. FIG. 8 illustrates a user interface for explaining to the user that a recreational handicap will be created if the user does not have a GHIN number.

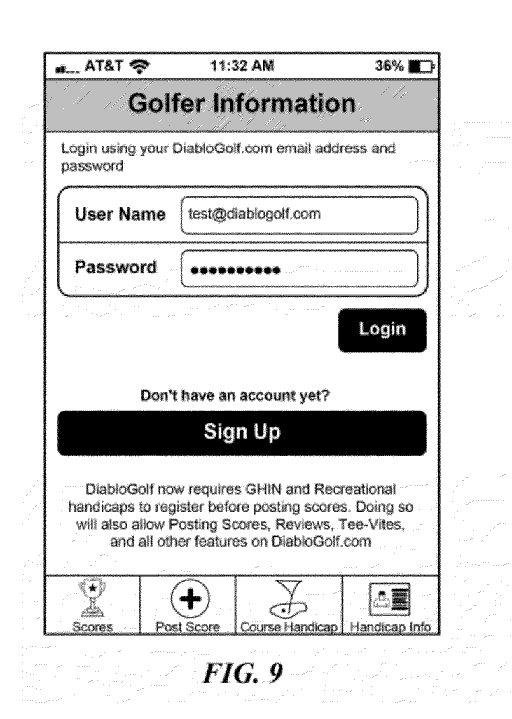

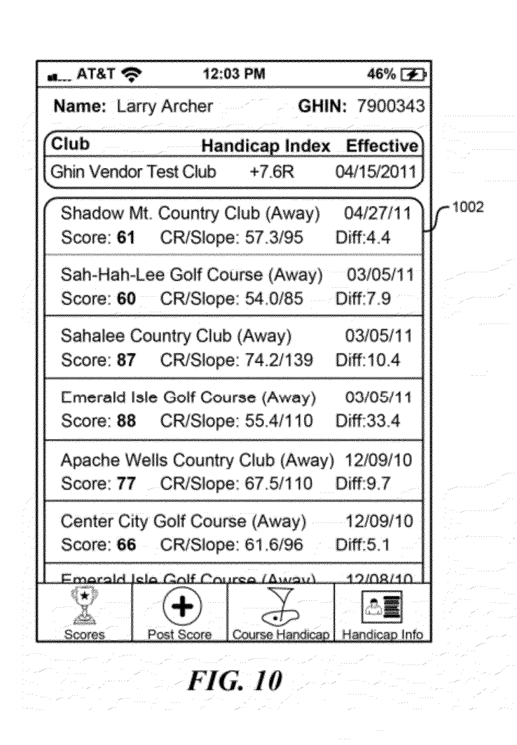

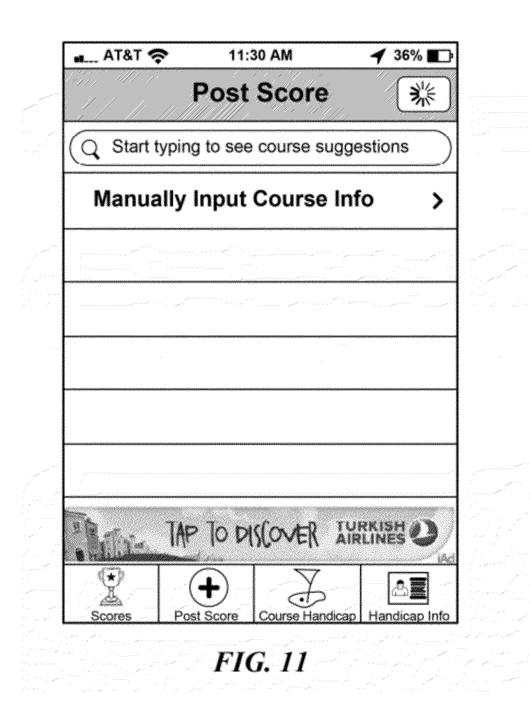

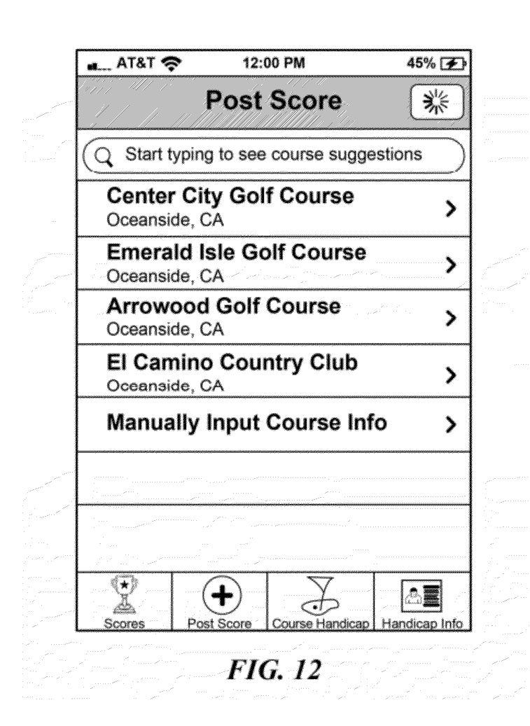

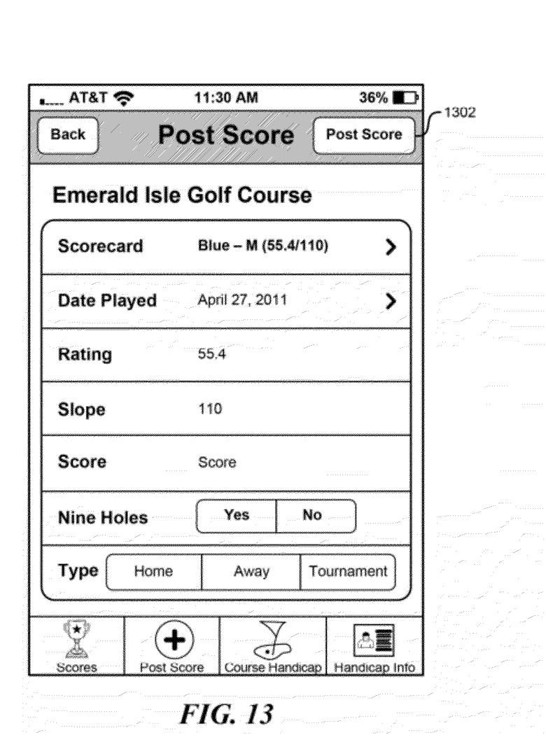

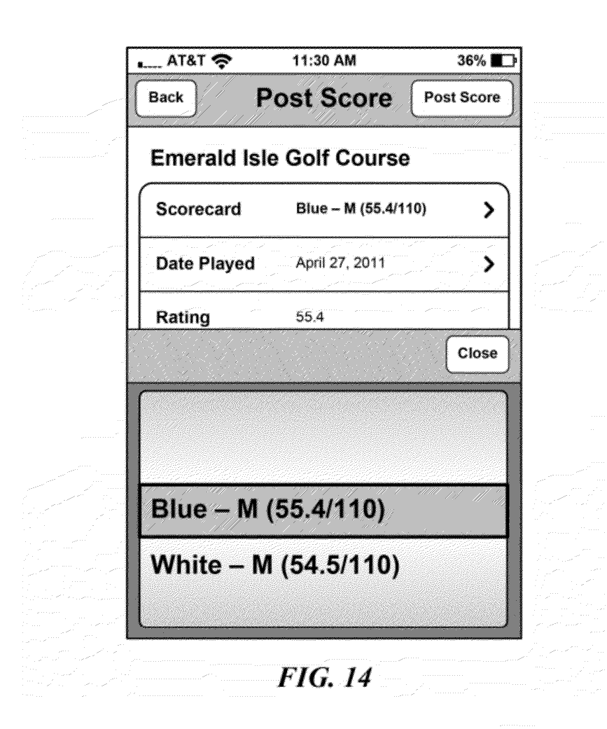

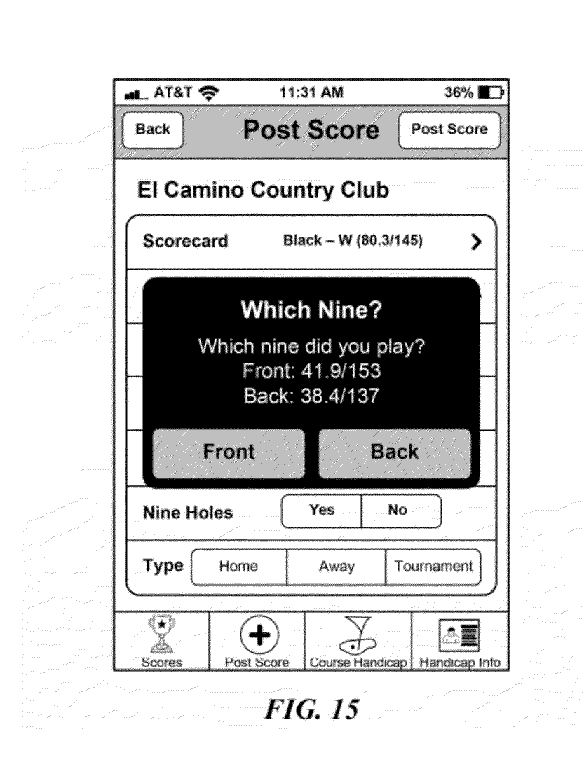

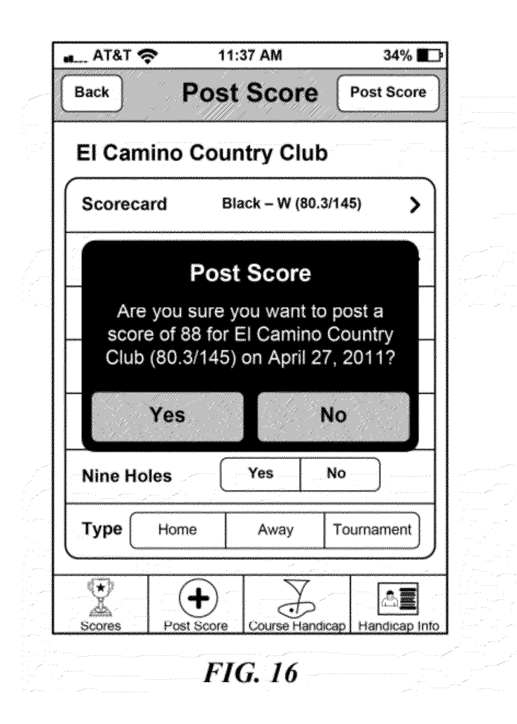

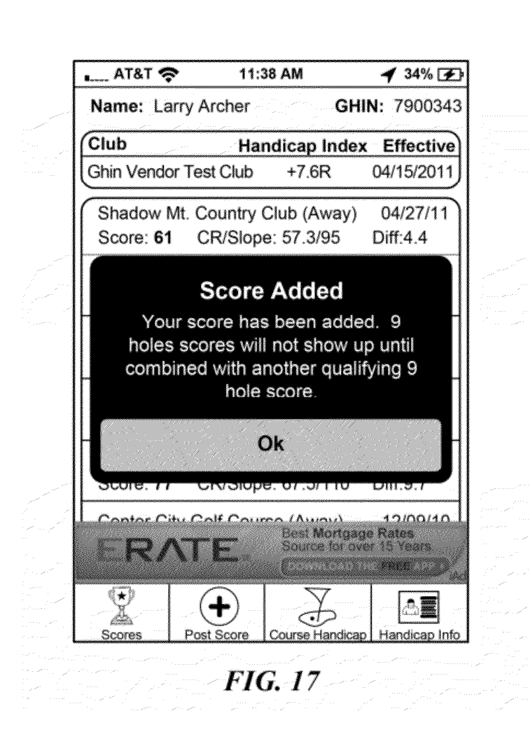

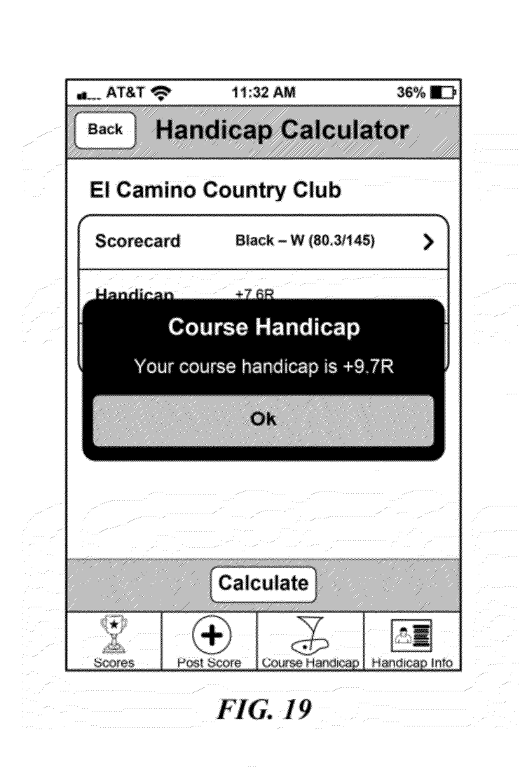

FIG. 9 illustrates a user interface for enabling the user to create an account. FIG. 10 illustrates a user interface for enabling the user to view historical golf score information. FIG. 11 illustrates a user interface for enabling the user to manually input course information, e.g., for golf courses that are not listed in the client application. FIG. 12 illustrates a user interface for enabling the user to select a golf course, e.g., a golf course that is nearby the user's present location as indicated by a GPS device associated with the user's mobile computing device. The golf courses may be listed in increasing order of distance from the user's present location. FIG. 13 illustrates a user interface for enabling the user to view information relating to a selected golf course. The user can select a “post score” region 1302 to post a score from a round played the selected golf course. FIG. 14 illustrates a user interface to enable the user to specify which set of tees the user played the round from. As is known in the golf community, playing from different tees poses different levels of difficulty. FIG. 15 illustrates a user interface to enable the user to specify which half of the golf course the user played in the event the user previously specified that the user only played nine holes. FIG. 16 illustrates a user interface to enable the user to confirm their score before the score is posted to the golf rating agency. FIG. 17 illustrates a user interface to indicate to the user that the received score for half a golf course will not be used for computation of handicap until another half golf course is played later. FIG. 8 illustrates a user interface for computation of a course handicap. The handicap computation can incorporate a user-provided score and golf-course-related slope/rating information to compute the handicap. The computed golf course handicap is displayed in the user interface illustrated in FIG. 19 and can be employed by the user to determine what their score should be at the selected golf course, e.g., in relation to a “par” score.

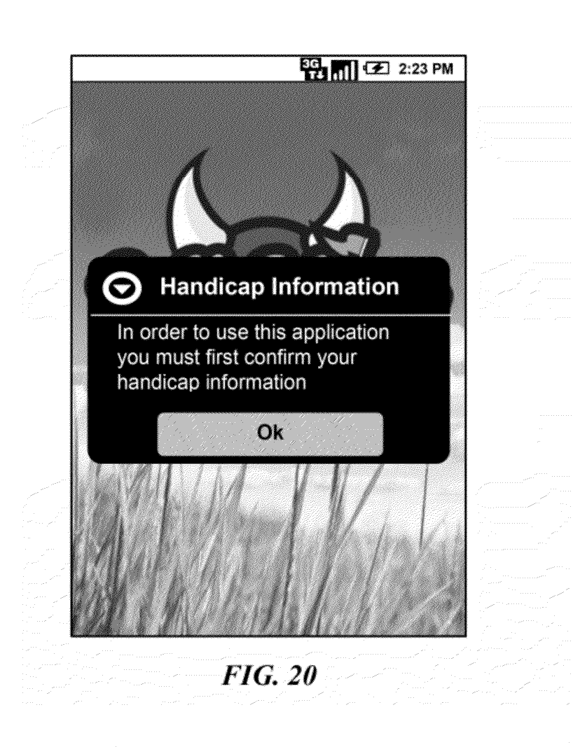

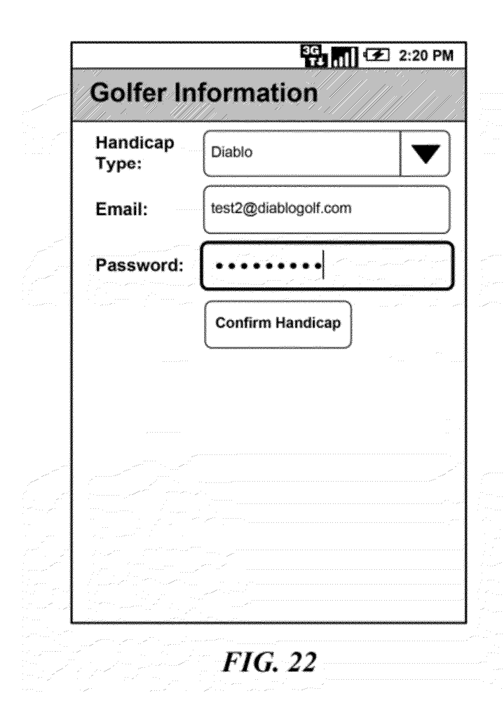

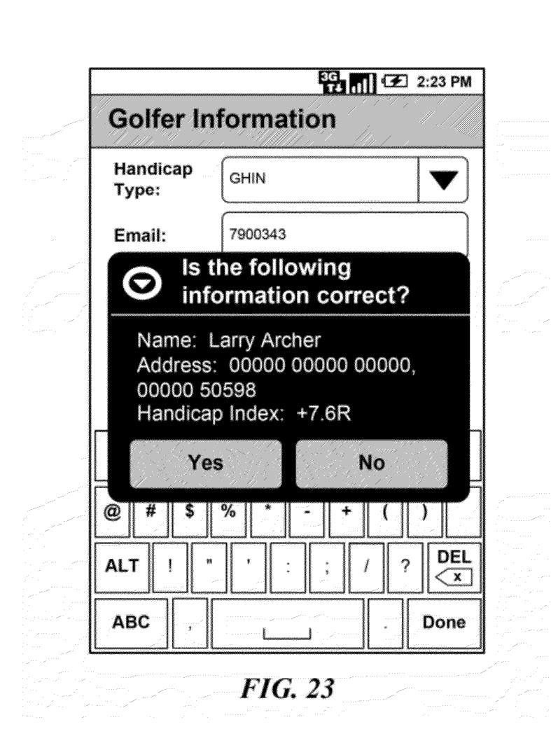

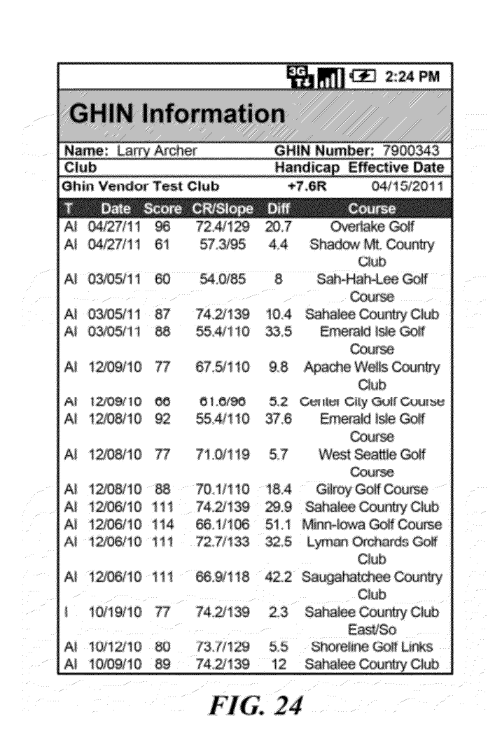

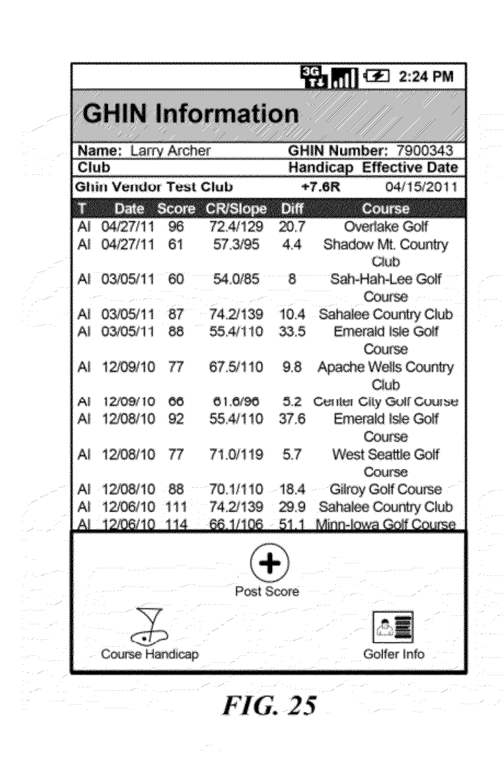

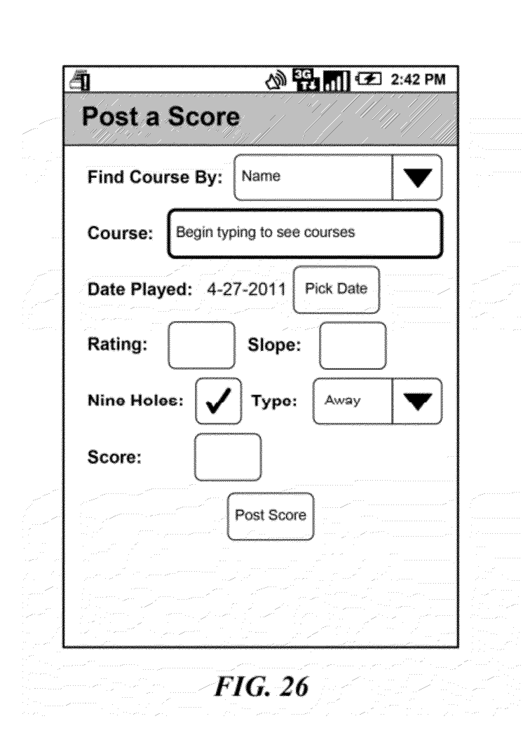

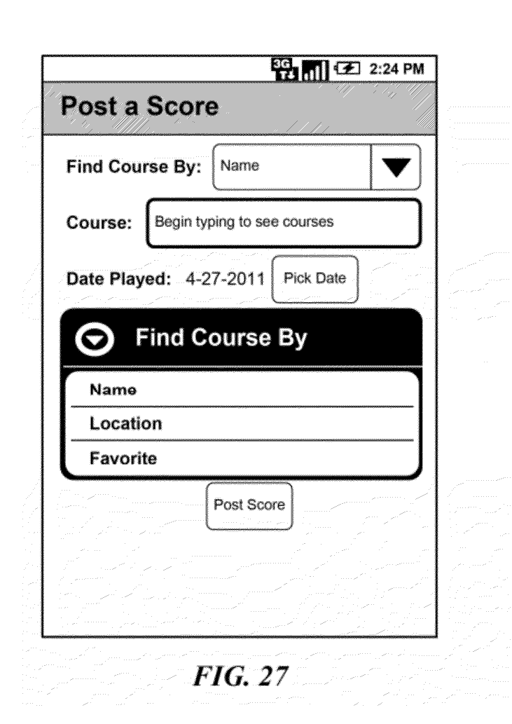

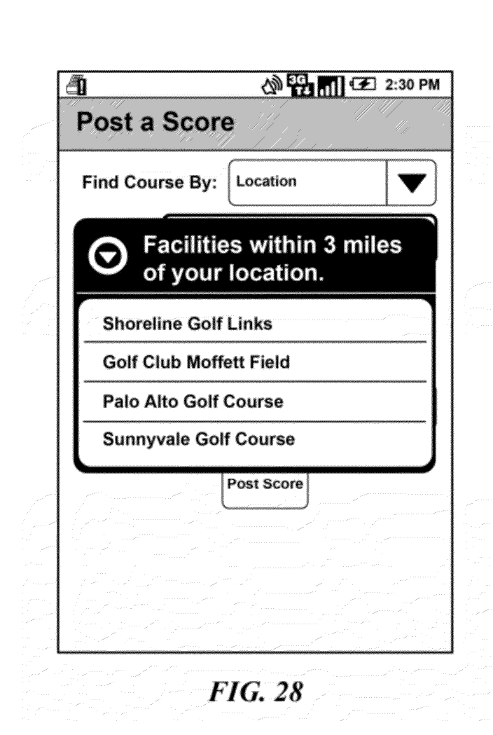

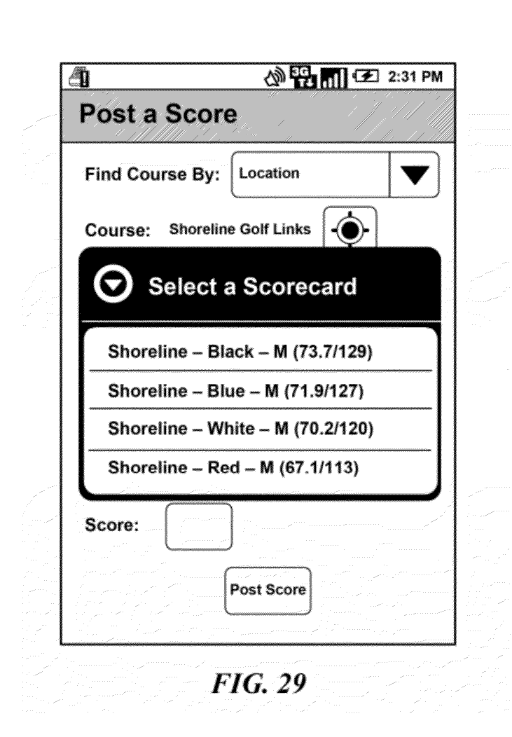

FIG. 20 illustrates a user interface to warn the user that the application cannot be used without confirming handicap information. FIG. 22 illustrates a user interface to enable the user to specify which handicap type is to be used, e.g., a recreational (“DiabloGolf”) handicap or a GHIN handicap. FIG. 23 illustrates a user interface used to verify the user's handicap information. FIG. 24 illustrates a user interface for providing the user with historical score information for the user. In various embodiments, a user may be able to view historical score information for other golfers. FIG. 25 illustrates a user interface for providing options to the user, e.g., to compute course handicaps, post scores, or view/update user information. FIG. 26 illustrates a user interface for enabling the user to post golf scores. The user can locate or identify a golf course where the user played one or more rounds, select the golf course and date of play, and provide their score. FIG. 27 illustrates a user interface for enabling the user to locate a golf course, e.g., to find a nearby golf course to play at, to reserve a tee time, to report scores, etc. FIG. 28 illustrates a user interface for identifying nearby golf courses to the user based on the user's present location. The present location may be determined based on information from a GPS device associated with the user's mobile computing device. FIG. 29 illustrates a user interface for enabling the user to select one of several scorecards from a selected golf course. Each listed scorecard may correspond to a different tee that is available at the selected golf course.

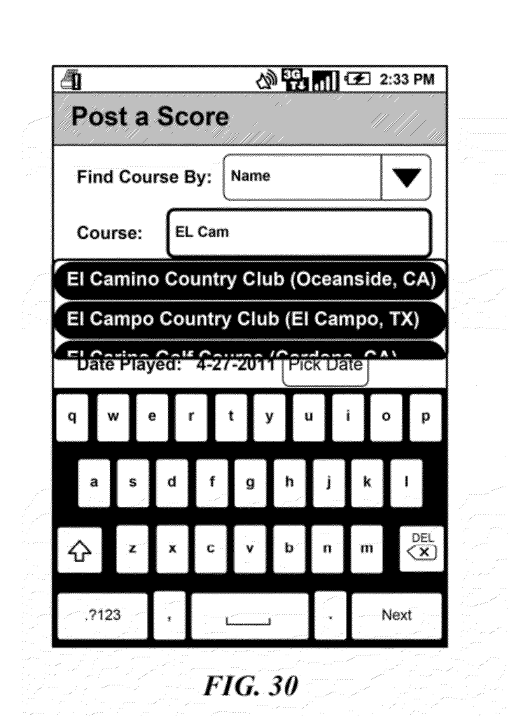

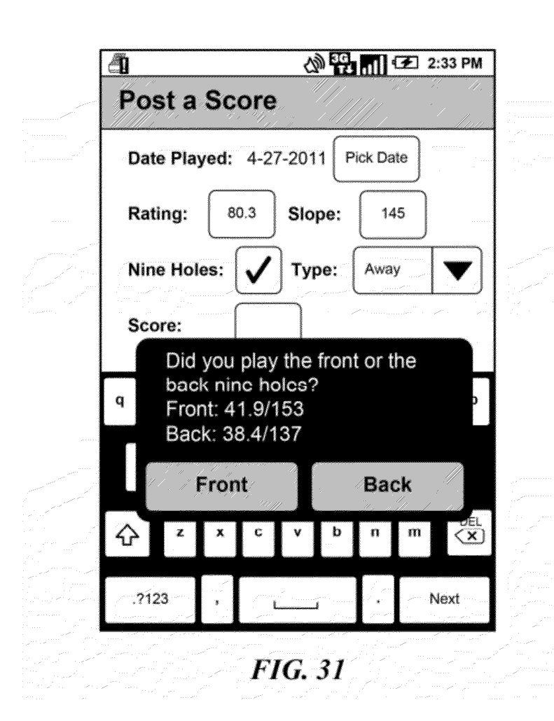

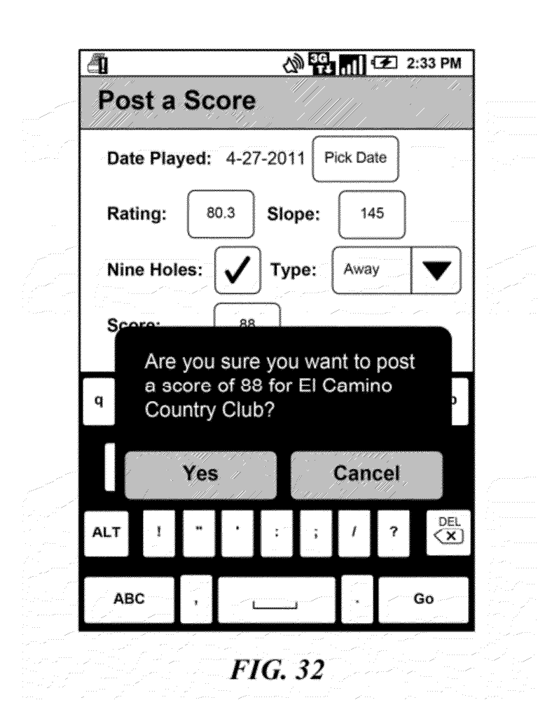

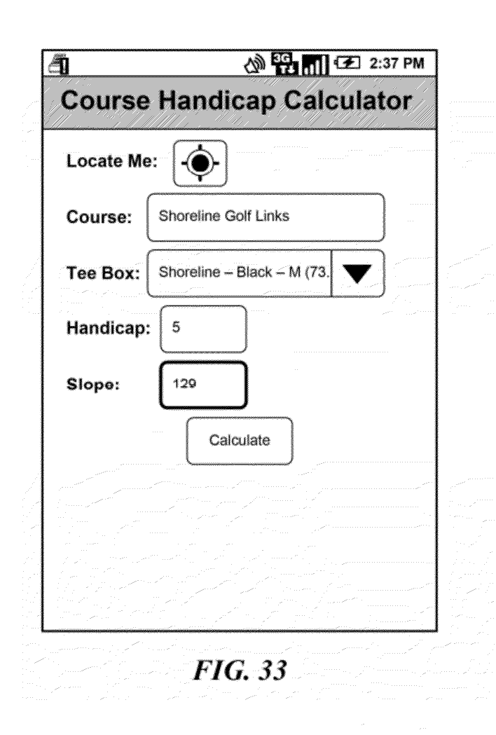

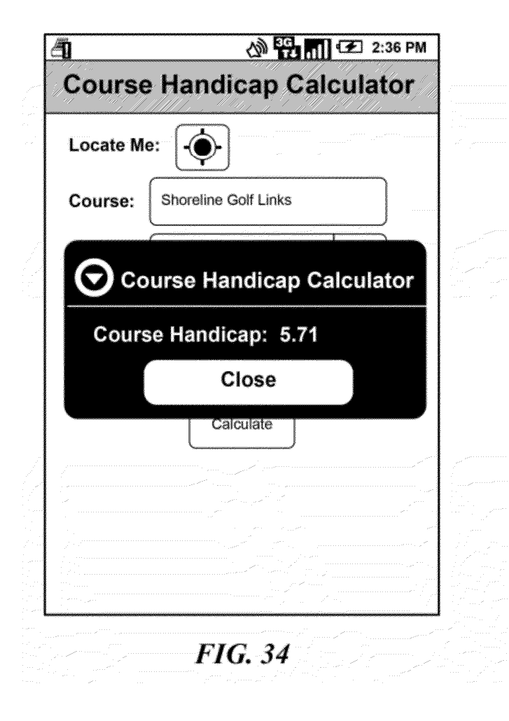

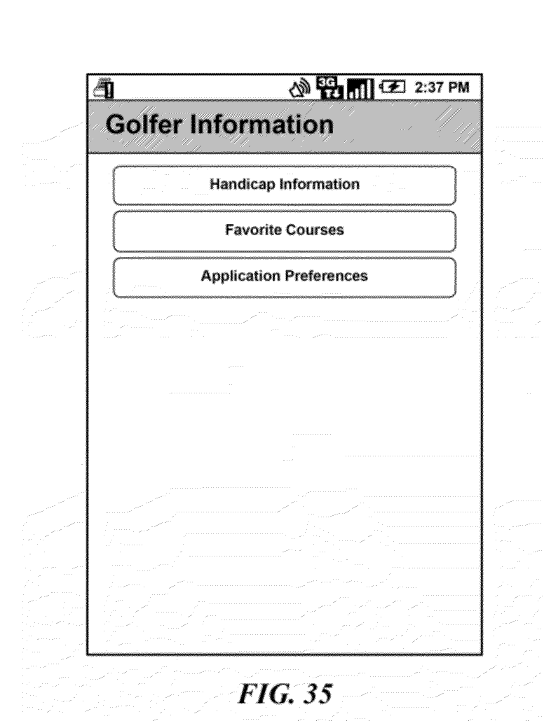

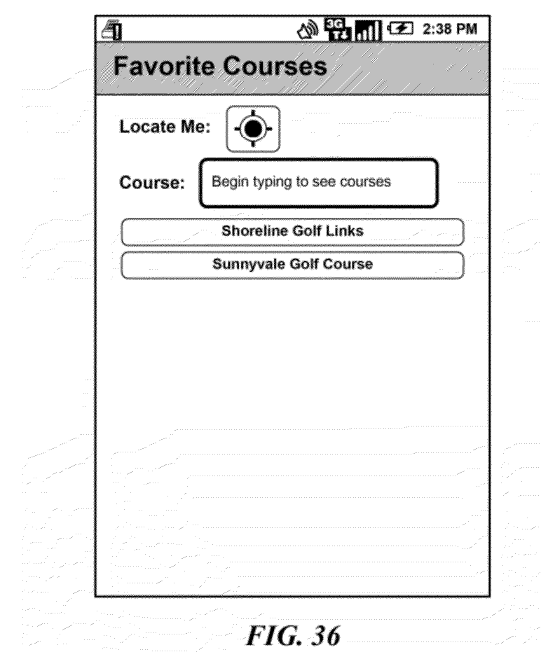

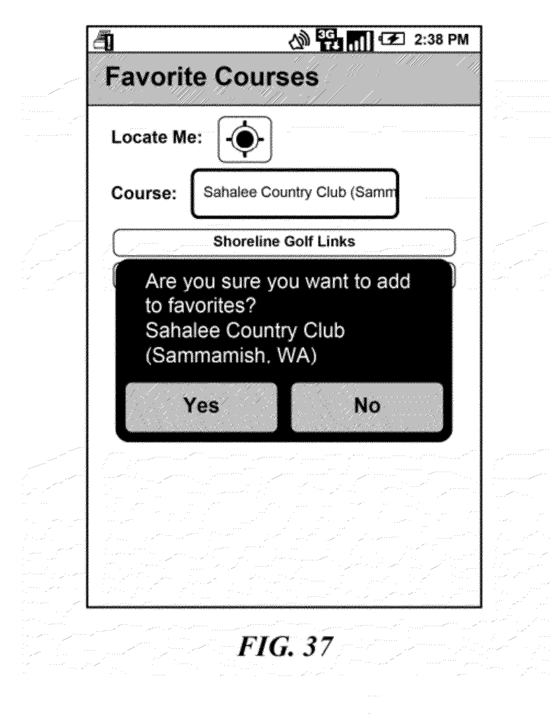

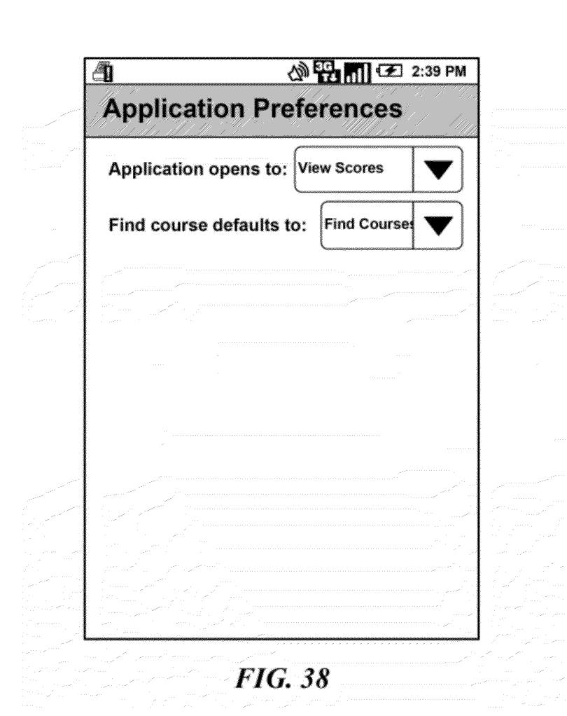

FIG. 30 illustrates a user interface for enabling the user to select a golf course, e.g., by typing in the name of the golf course. As additional letters are entered, the client software can “auto complete” the name of the golf course. FIG. 31 illustrates a user interface for asking the user which half of the golf course the user played. FIG. 32 illustrates a user interface that can be used for confirming with the user whether the specified score should be posted. FIG. 33 illustrates a user interface that can be used by a user to compute the user's course handicap. FIG. 34 illustrates a user interface that can be used to display to the user the user's computed course handicap. FIG. 35 illustrates a user interface that a user can employ to select aspects of the user interface. FIG. 36 illustrates a user interface to enable the user to select golf courses nearby the user's present location. FIG. 37 illustrates a user interface requesting the user to confirm that they want to add a selected golf course to their list of favorite golf courses. FIG. 38 illustrates a user interface for enabling a user to specify preferences.

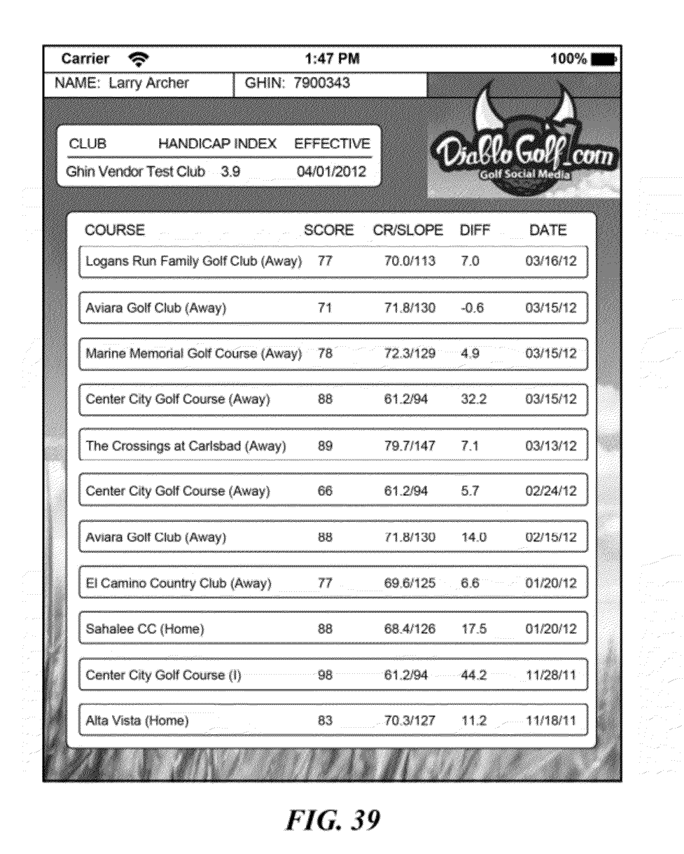

FIGS. 39-59 illustrate aspects of the user interface that may differ from the user interface described above in relation to the previously described figures.

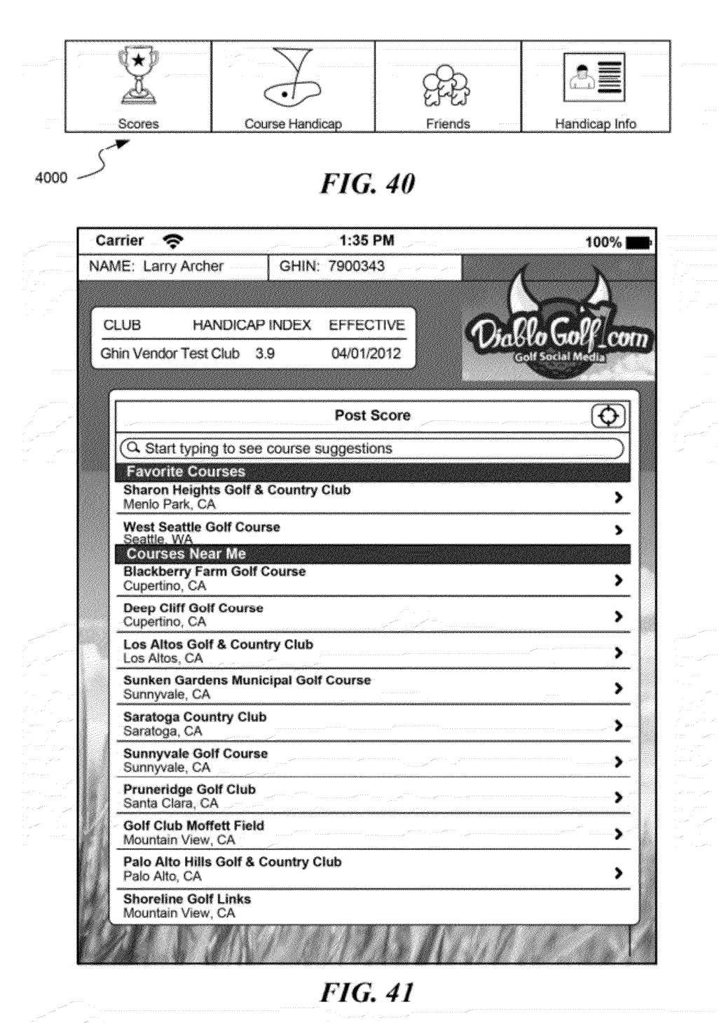

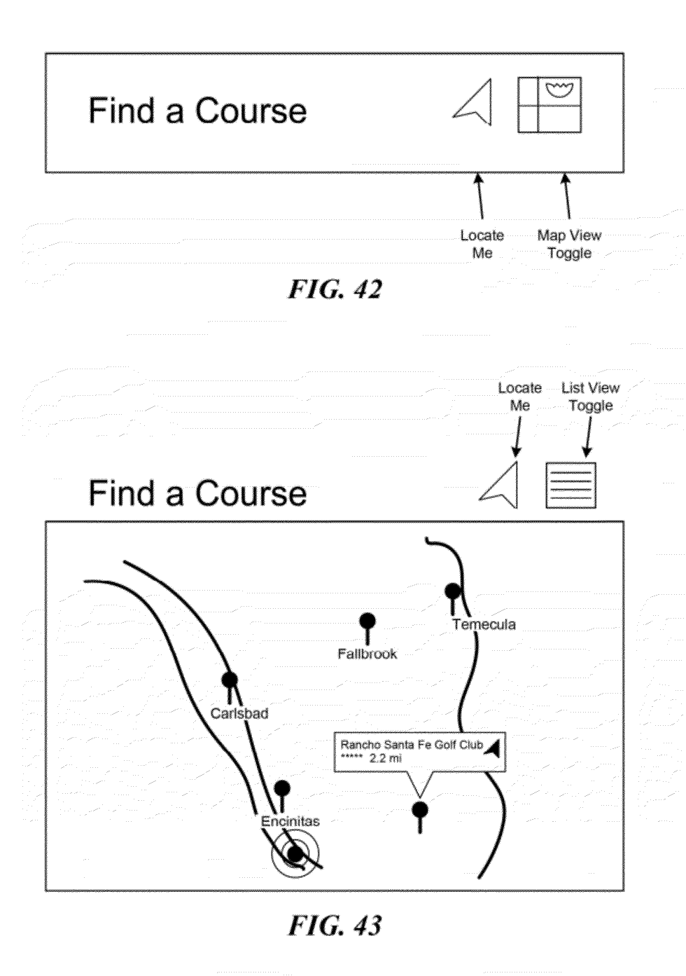

FIG. 39 illustrates a user interface for viewing a user's historical score information. If the users selects a name of a listed golf course, the user can view additional information about that course. The user can also view additional information about their posted scores, e.g., statistics, how their peers did at that golf course, etc. FIG. 40 illustrates a user interface that may appear near a footer (e.g., near the bottom of the screen) section of the user interface. The user interface can include one or more regions 4000 to select, e.g., scores, courses, friends, or handicap information. When the user selects one of the displayed regions, a different user interface may be displayed, e.g., with pertinent detail. FIG. 41 illustrates a user interface for selecting a golf course near the user's present location, e.g., as indicated by a GPS device associated with the mobile computing device. FIG. 42 illustrates a user interface that may be displayed to enable the user to find a golf course, e.g., by using GPS information, displaying a map that the user can select a golf course from, etc. FIG. 43 illustrates such a map that a user can employ to select a golf course nearby the user's present location. When the user selects a golf course, the client software may display details pertaining to the selected golf course. Examples of such details can include, e.g., metadata about the course (address, phone numbers, fees, website, course statistics, etc.), recent photographs, recent scores, recent reviews, recent check ins at this location, and actionable items: Post a Score, Post a Review, Calculate Handicap, Check In, Post a Picture, Add to Favorites, Get Directions, etc.

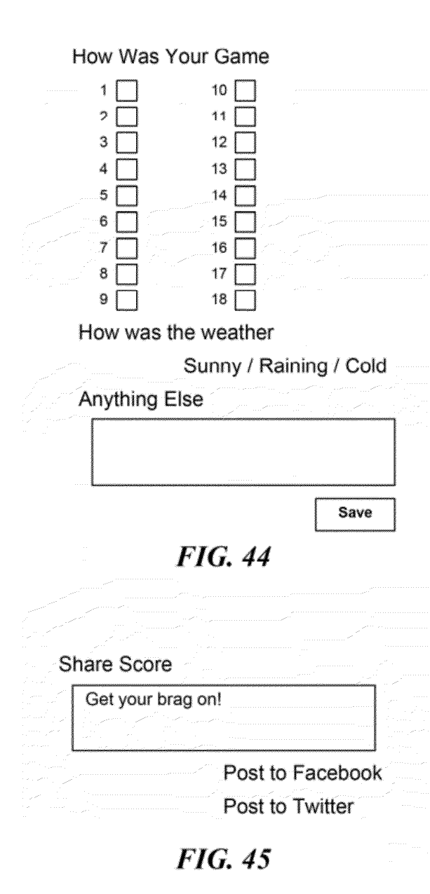

When a user posts scores, the user can add additional information for statistics tracking purposes, e.g., hole-by-hole score information, a photo of their scorecard, weather information, and/or free form text to add any additional metadata the user wants to track about their round. This information can be stored at a server for future download via a web site, mobile application, etc. FIG. 44 illustrates the user interface that can collect such information.

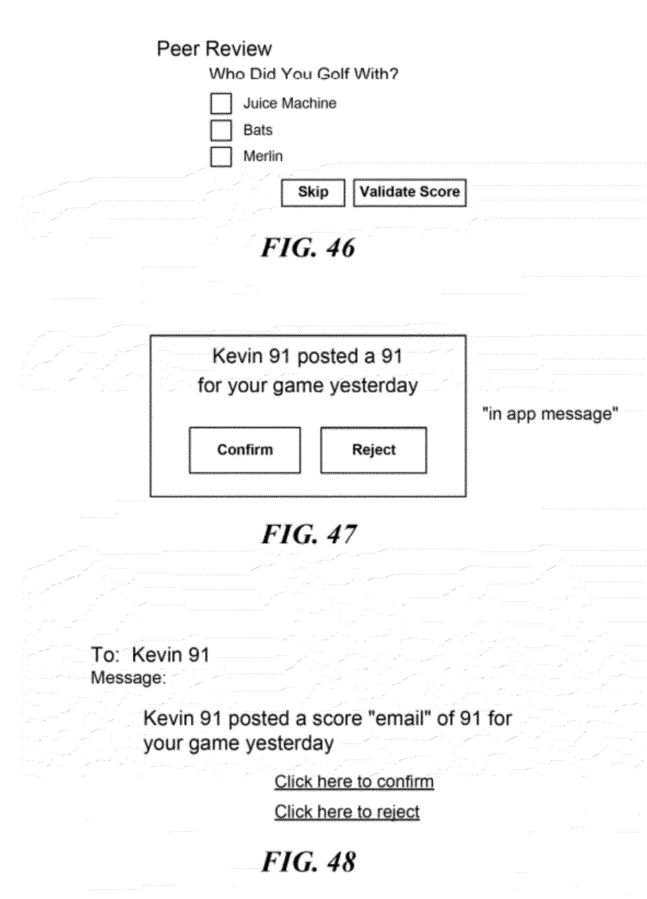

FIG. 45 illustrates a user interface to enable users to share their results, e.g., via social networking websites and applications. FIG. 46 illustrates a user interface to enable users to solicit peer reviews. As examples, a golfer may solicit peer reviews from others who the user golf with, e.g., to verify scores, provide commentary, etc. When the user selects others, e.g., other golfers the user golf with, the technology may transmit messages to the other golfers, e.g., using electronic mail, instant messaging, social networking, phone text messaging, etc. FIG. 47 illustrates a text message, e.g., that can be displayed from the client software or mobile computing device. FIG. 48 illustrates the electronic mail message, e.g., including links that the recipient can use to confirm or reject the score.

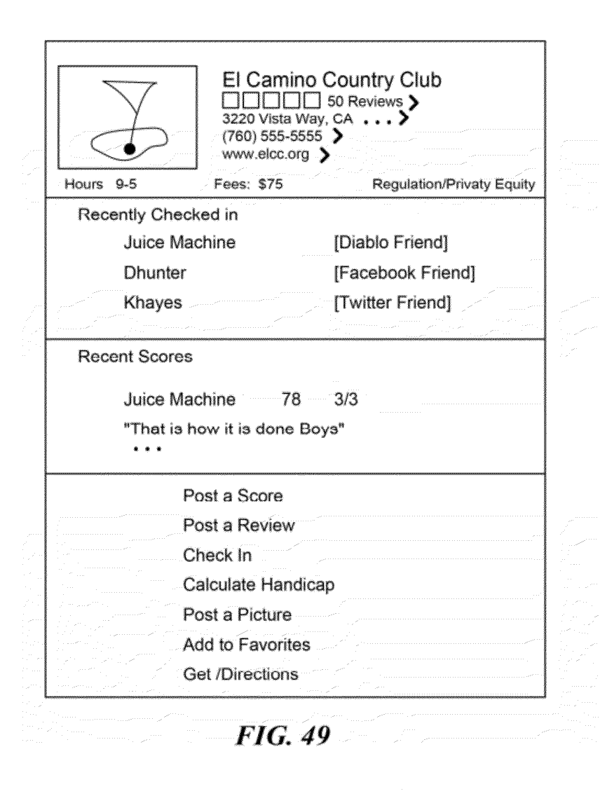

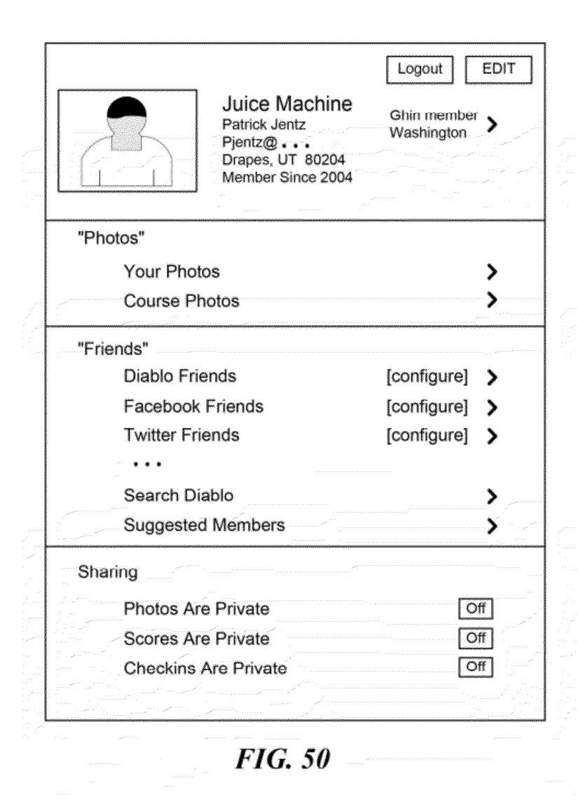

FIG. 49 illustrates a user interface illustrating various options that the client software may provide to the user, e.g., to post scores, reviews, check in for tee times, post photographs, add golf courses to favorites, get directions to golf courses, etc. When the user posts photographs, the photographs may be available via a website, client software, etc. FIG. 50 illustrates the user interface illustrating options that a user can set, e.g., in a profile page. The user can also indicate various privacy settings, e.g., pertaining to photographs, scores, check in to golf courses, etc. Once users have uploaded information (e.g., photographs, scores, etc.), the user may manage the uploaded information, e.g., to edit it, etc.

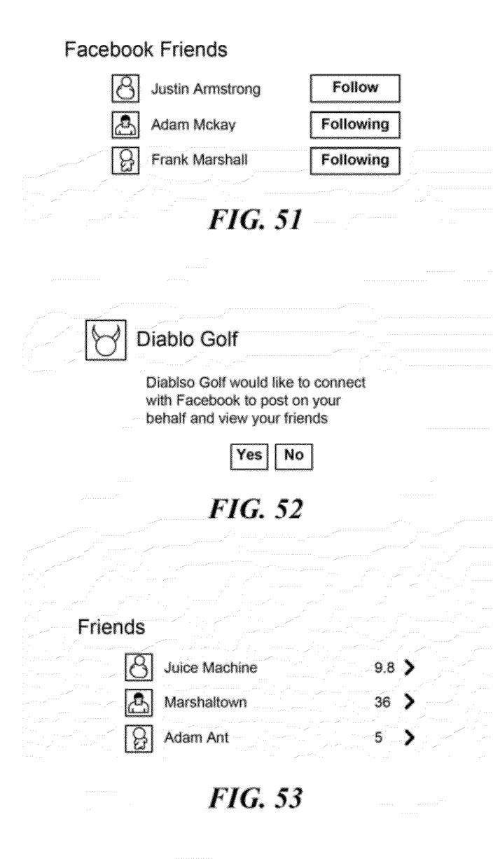

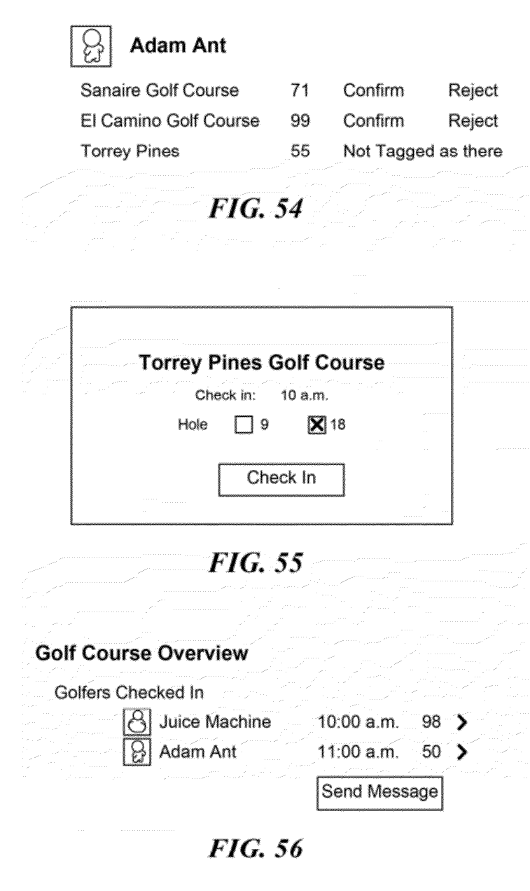

FIG. 51 illustrates a user interface to enable the user to determine which other golfers the user is following or to indicate which other golfers the user would like to follow. By following other golfers, the user may be able to view when that other golfer checks into golf courses, post scores or photographs, etc. FIG. 52 illustrates a user interface that a social networking site, e.g., Facebook, may display to confirm that an application can take various actions on behalf of the user. FIG. 53 illustrates a user interface for viewing friends and their handicaps. FIG. 54 illustrates a user interface that the user can employ to confirm or reject friends.

FIG. 55 illustrates a user interface that enables the user to check into a golf course, e.g., at approximately a reserved tee time. The user can also reserve tee times and/or indicate whether the user will be playing only half the course and, if so, which half. FIG. 56 illustrates a user interface for sending messages to the user's friends.

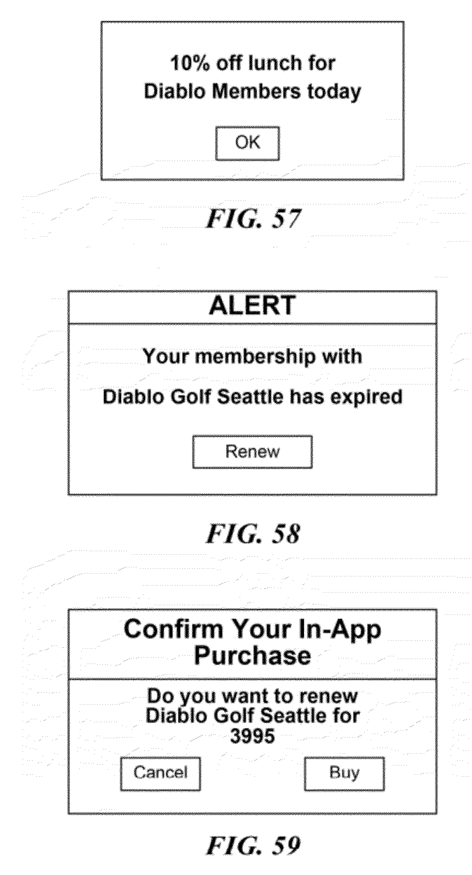

FIG. 57 illustrates a user interface for providing advertising to users. As an example, when the user is nearby or playing at a golf course, the user may be provided an advertisement or incentive to acquire goods or services at the golf course. As a further example, the user may be provided the advertisement or incentive at the time of check-in. FIG. 58 illustrates a user interface for enabling the user to renew their subscription using the client software. FIG. 39 illustrates a user interface for confirming the purchase.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims. Applicants do not claim any particular affiliation with the USGA or with GHIN.

I/We claim:

1. A method performed by a computing device for tracking a golf handicap, comprising:
receiving an identification of one of at least two golf handicap rating agencies a user is affiliated with;
receiving a golf score for the user; and
electronically providing the received golf score to the identified rating agency.

2. The method of claim 1, further comprising receiving a golf handicap for the user based at least on the provided golf score.

3. The method of claim 1, wherein the golf score for the user relates to results of the user at a golf course and the golf course is unaffiliated with the identified golf handicap rating agency.

4. The method of claim 1, further comprising providing the received golf score to both of the golf handicap rating agencies.

5. A system, comprising:
a component configured to determine with which of at least two golf handicap rating agencies a user is affiliated;
a component configured to receive a score from a client computing device; and
a component configured to electronically provide the received golf score to the identified rating agency.

6. The system of claim 5, further comprising a component configured to receive a golf handicap for the user based at least on the provided golf score.

7. The system of claim 5, wherein the golf score for the user relates to results of the user at a golf course and the golf course is unaffiliated with the identified golf handicap rating agency.

8. The system of claim 5, further comprising a component configured to provide the received golf score to both of the golf handicap rating agencies.

9. A computer-readable storage medium storing instructions that, when executed by a computing device, cause the computing device to perform a method for tracking a golf handicap, comprising:
receiving an identification of one of at least two golf handicap rating agencies the user is affiliated with;
receiving a golf score for a user; and
electronically providing the received golf score to the identified rating agency.
